(19) United States
(12) Patent Application Publication
(10) Pub. No.: US 2016/0179581 A1
(43) Pub. Date: Jun. 23, 2016

(54) CONTENT-AWARE TASK ASSIGNMENT IN DISTRIBUTED COMPUTING SYSTEMS USING DE-DUPLICATING CACHE

(71) Applicant: NetApp, Inc., Sunnyvale, CA (US)

(72) Inventors: Gokul Soundararajan, Sunnyvale, CA (US); Jingxin Feng, San Jose, CA (US); Xing Lin, Salt Lake City, UT (US)

(73) Assignee: NetApp, Inc.

(21) Appl. No.: 14/576,719

(22) Filed: Dec. 19, 2014

(51) Int. Cl. G06F 9/50; G06F 17/30

(52) U.S. Cl. CPC G06F 9/5016; G06F 17/30156; G06F 17/30097

(57) ABSTRACT

Systems, devices, and methods are described for performing content-aware task assignment. A resource manager in a distributed computing system can identify tasks associated with a file. Each task can involve processing multiple data blocks of the file (e.g., in parallel with other processing by other tasks). The resource manager can provide block identifiers for the blocks to each of multiple computing nodes. Each computing node can store a respective subset of the blocks in a respective cache storage medium. Each subset of blocks stored at a node can be identified from the block identifiers. The resource manager can assign the task to a selected one of the computing nodes. The task can be assigned based on the selected computing node having larger subset of the blocks than one or more other computing nodes in the distributed computing system. In some embodiments, computing nodes can de-duplicate cached data using block identifiers.

### TECHNICAL FIELD

This disclosure relates generally to computer-implemented methods and systems for distributed processing and more particularly relates to content-aware task assignment in distributed computing systems using de-duplicating caches.

### BACKGROUND

Analytics software can be implemented on distributed computing systems for analyzing data (e.g., user click streams, social network data, system log files, etc.). Distributed computing systems can divide analytical jobs into tasks for assignment to nodes in the distributed computing system.

Distributed computing systems may store data in persistent storage devices, such as high-density drives. To accelerate processing in distributed computing systems, data may also be cached at computing nodes in cache storage media, such as a dynamic random-access memory device. Persistent storage devices may store larger volumes of data than cache storage media, and can be used for long-term data storage. Data may be accessed from cache storage media at a higher rate as compared to persistent storage devices, and can be used for relatively short-term data storage during processing operations.

Prior solutions for analyzing data using distributed computing systems may present disadvantages. One disadvantage may involve inefficient allocation of tasks to computing nodes. For example, a resource manager of the distributed computing system may assign tasks to nodes based on criteria that do not account for which of the nodes has readily available access to data used in the tasks. Thus, even though a given node in a distributed computing system may store data required for a given task in cache storage media that is quickly accessible, a resource manager for the distributed computing system may assign the task to another node that has not cached the required data. The node to which the task is assigned must then retrieve the data from the persistent storage device. This retrieval of the required data from the persistent storage device can decrease the speed at which the distributed computing system can complete one or more analytical processes.

Another disadvantage may involve duplication of data at computing nodes. For example, a computing node in a distributed computing system may store data in cache storage media without regard to whether the same data (e.g., the same content) is already stored at the computing node. The failure to determine whether content is already cached at a computing node may result in inefficient usage of cache storage media.

### SUMMARY

Systems, devices, and methods are described for performing content-aware task assignment in distributed computing systems. For example, a computing device used for managing resources in a distributed computing system can identify tasks associated with a file. Each task can involve processing multiple data blocks of the file (e.g., in parallel with other processing by other tasks). The computing device can provide block identifiers for the blocks to each of multiple computing nodes of the distributed computing system. Each computing node may determine that a subset of the blocks are stored in a cache storage medium of the computing node. Each subset of blocks stored at a node can be identified from the block identifiers. The computing device can assign the task to a selected one of the computing nodes. The task can be assigned based on the selected computing node having a larger subset of the blocks than one or more other computing nodes in the distributed computing system. In some embodiments, one or more of the computing nodes can perform data de-duplication operations using block identifiers.

These illustrative examples are mentioned not to limit or define the disclosure, but to provide examples to aid understanding thereof. Additional embodiments and examples are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 is a block diagram depicting an example of a distributed computing system that can perform content-aware task assignment according to some embodiments of the present invention.

FIG. 2 is a block diagram depicting an alternative example of a distributed computing system that can utilize a distributed file system to perform content-aware task assignment according to some embodiments of the present invention.

FIG. 3 is a flow chart depicting an example of a method for performing content-aware task assignment in distributed computing systems according to some embodiments of the present invention.

FIG. 4 is a diagram depicting an example of a resource manager receiving a job that can be executed using content-aware task assignment in a distributed computing system according to some embodiments of the present invention.

FIG. 5 is a diagram depicting an example of the resource manager obtaining a file recipe that includes block identifiers for the file associated with the received job according to some embodiments of the present invention.

FIG. 6 is a diagram depicting an example of the resource manager dividing the job into tasks using the block identifiers from the obtained file recipe according to some embodiments of the present invention.

FIG. 7 is a diagram depicting an example of the resource manager providing the block identifiers associated with one of the tasks to computing nodes of the distributed computing system according to some embodiments of the present invention.

FIG. 8 is a diagram depicting an example of the resource manager receiving replies from the computing nodes identifying respective numbers of blocks from the file stored in the respective caches of the computing nodes according to some embodiments of the present invention.

FIG. 9 is a diagram depicting an example of the resource manager assigning the task to one of the computing nodes based on the computing node having a larger number of the blocks from the file stored in the cache of the computing node according to some embodiments of the present invention.

FIG. 10 is a flow chart depicting an example of a method executed by a computing node to utilize block identifiers for identifying cached file blocks and reducing duplication of stored content when executing a task according to some embodiments of the present invention.

FIG. 11 is a block diagram depicting examples of a computing node and other systems used in content-aware task assignment according to some embodiments of the present invention.

FIG. 12 is a block diagram depicting an alternative example of a computing node used in content-aware task assignment according to some embodiments of the present invention.

### DETAILED DESCRIPTION

Systems, devices, and methods are described for content-aware task assignment in distributed computing systems. Content-aware task assignment can involve scheduling or otherwise assigning tasks to specific computing nodes based on a similarity between the content associated with the task and content that is cached or otherwise stored in a computing node. For example, a task scheduler or other resource manager can receive a job submission involving a file or set of files, obtain a set of fingerprints or other identifiers for data blocks in the file, and, for each task of the job, assign the task to a computing node that has cached or otherwise stored a sufficiently large number of data blocks associated with the task. The number of data blocks that are cached or otherwise stored at a given computing node can be determined using the fingerprints or other identifiers for data blocks in the file.

The following example is provided to help introduce (without limitation) the general subject matter of certain embodiments. A file that is stored in a persistent storage device of a distributed computing system can be partitioned or otherwise divided into data blocks. A cryptographic hash function can be performed for each data block to generate a fingerprint or other block identifier for the block. The fingerprints or other block identifiers can be provided to a resource manager in the distributed computing system.

Subsequently, in a task assignment process, the resource manager can use the fingerprints to determine how to assign tasks to various computing nodes in the distributed computing system. For example, the resource manager can receive a job that references a particular file and divide the job into tasks that process or otherwise utilize different portions of the file (e.g., different subsets of data blocks that comprise the file). One or more of the computing nodes may have cached at least some of the data blocks in prior operations. For example, at least some of the data blocks may be cached in a cache storage medium or (for implementations in which a shared network storage system is used to provide persistent data storage) in a persistent storage medium local to a give computing node. The resource manager can assign the task based on which of the computing nodes in the distributed computing system has cached a larger number of blocks associated with the task. For example, the resource manager can provide the fingerprints or other block identifiers of data blocks associated with the task to each computing node. Each computing node can compare the fingerprints or other block identifiers to a local index and notify the resource manager of how many data blocks are cached at the computing node. The resource manager can assign the task to a computing node that reports a larger number of cached blocks than one or more other computing nodes. In some embodiments, the task can also be assigned based on one or more other parameters associated with the performance of the computing nodes (e.g., amount of available processing resources, location of computing nodes, reliability of connections to computing nodes, etc.).

As used herein, the term “job” can refer to one or more requested actions to be performed on a file or a set of files by a distributed computing system. A job can be sub-divided into multiple tasks to be performed by one or more computing nodes in the distributed computing system.

As used herein, the term “task” can refer to one or more processing operations to be performed on one or more blocks of a file. A job can be subdivided into multiple tasks by a computing device that performs one or more resource management functions in a distributed computing system. In some embodiments, multiple tasks can be executed by multiple computing nodes of a distributed computing system in parallel.

As used herein, the term “block” can refer to a fragment, partition, chunk, or other storage object corresponding to a portion of a file. A block can be stored as a contiguous unit in a storage medium. An example of a block is a sequence of bytes or bits of data having a predetermined length.

As used herein, the term “block identifier” can refer to any data that is usable for uniquely identifying a block of a file. In some embodiments, a block identifier can be generated from the content of a corresponding data block such that the block identifier is indicative of or otherwise corresponds to the content of the data block. An example of a block identifier is a fingerprint for the block. In some embodiments, a fingerprint or other block identifier can be obtained using a suitable cryptographic hash function, such as (but not limited to) SHA-1.

As used herein, the term “cache storage medium” can refer to any suitable medium for storing data that provides high-speed access to the data during processing operations. For example, a cache storage medium may be configured to access data more quickly than a persistent storage device. An example of cache storage medium is a dynamic random-access memory device.

As used herein, the term “persistent storage device” can refer to storage media that can store large amounts of data. A persistent storage device may provide larger storage capacity than a cache storage medium. A persistent storage device may access stored data at a slower rate than a cache storage medium.

In some embodiments, persistent storage in a distributed computing system can be implemented as a distributed storage system using multiple persistent storage devices in respective computing nodes. In additional or alternative embodiments, persistent storage in a distributed computing system can be implemented using a shared network storage device accessible by multiple computing nodes. For embodiments in which a shared network storage device is used to provide persistent storage, local persistent storage devices at each computing node can be used as cache storage media.

In some embodiments, the content-aware task assignment described herein can provide improvements in the technological field of distributed processing or other related fields. In one example, using content-aware task assignment can reduce communication traffic to and from a persistent storage device associated with a distributed computing system. Communication traffic can be reduced by maximizing the use of cached data at computing nodes. In another example, using content-aware task assignment can reduce the processing load on the persistent storage device. The processing load can be reduced by increasing the proportion of the processed data that is accessed from a cache at a computing node rather than from the persistent storage device. In another example, using content-aware task assignment can improve the performance of data analytics applications and other applications, as these applications will access at least some processed data from a cache in a computing node having higher data transfer rates rather than from a persistent storage device having lower data transfer rates. In another example, a fingerprint index or other block identifier index at a computing node can be used to de-duplicate data that is cached or otherwise stored in cache storage media at the computing node. This de-duplication of data can increase caching efficiency at the computing node.

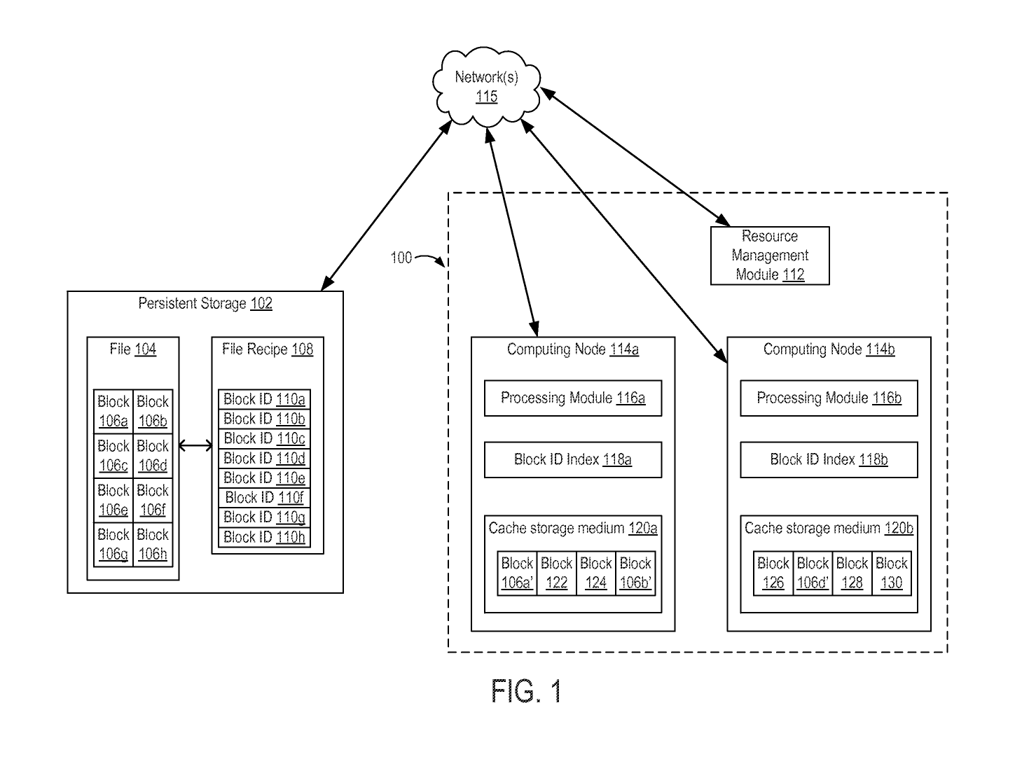

Referring now to the drawings, FIG. 1 is a block diagram depicting an example of a distributed computing system 100 that can perform content-aware task assignment. The distributed computing system 100 can include multiple computing nodes 114a, 114b communicatively coupled to a data network 115. The computing nodes 114a, 114b can execute multiple processing tasks in parallel. In some embodiments, one or more of the computing nodes 114a, 114b can execute a resource management module 112 or other suitable computing instructions for scheduling or assigning tasks and/or otherwise managing resources in the distributed computing system 100.

The distributed computing system 100 can also include or be communicatively coupled to a persistent storage device 102. The persistent storage device 102 can include one or more devices that are communicatively coupled to a data network 115 for the purpose of providing access to files or other data by the distributed computing system 100. The persistent storage device 102 may include, for example, high-density storage media that can store larger amounts of data than any of the computing nodes 114a, 114b in the distributed computing system 100. The persistent storage device 102 may also include one or more processing devices that execute a storage operating system. The storage operating system can implement one or more file systems.

The persistent storage device 102 can be a server-class computer that provides storage services relating to the organization of information on one or more writable, persistent storage media. Examples of these persistent storage media include hard disk drives, flash drives, tape drives, solid state drives, read only memory (“ROM”), storage devices of another type, or a combination thereof. In some embodiments, the persistent storage device 102 can communicate with devices in the distributed computing system 100 via a data network 115, as illustrated in FIG. 1. In additional or alternative embodiments, the persistent storage device 102 can communicate with devices in the distributed computing system 100 directly via one or more suitable data buses.

For illustrative purposes, FIG. 1 illustrates the persistent storage device 102 as a single functional block. However, the persistent storage device 102 can be implemented in any suitable manner. In some embodiments, the persistent storage device 102 can be implemented on a single server device. In other embodiments, the persistent storage device 102 can be implemented as a distributed device or a virtual device using multiple servers or other computing devices or system(s). In other embodiments, the persistent storage device 102 can be implemented as a distributed storage system using multiple persistent storage devices included in respective computing nodes. The functions of the persistent storage device 102 may be adapted to a variety of storage server architectures and techniques, including a network-attached storage (“NAS”) system, a storage attached network (“SAN”), or a direct-attached storage (“DAS”) system.

As depicted in FIG. 1, the persistent storage device stores one or more files 104 and one or more file recipes 108. The file 104 can be stored as blocks 106a-h of data. Each of the blocks 106a-h can be a fragment, partition, block, or other storage object corresponding to a portion of a file 104. Each of the blocks 106a-h block can be stored as a contiguous unit in a storage medium. An example of a block is a sequence of bytes or bits of data having a predetermined length. For example, the persistent storage device 102 may execute a file system that stores a file 104 in data blocks of 4 KB in length.

Each of the files 104 can be associated with a corresponding file recipe 108. The file recipe 108 can be metadata or other suitable data that includes a set of block identifiers 110a-h for the file 104. In some embodiments, the file recipe 108 can be stored as an auxiliary file having a specified file extension in the same directory as the file 104. The block identifiers 110a-h can be used to retrieve corresponding blocks 106a-h of the file as stored on a storage media. The block identifiers 110a-h can include any data that is usable for uniquely identifying a block of a file. An example of a block identifier is a fingerprint for a block that can be obtained using a suitable cryptographic hash function, such as (but not limited to) SHA-1.

A fingerprint or other block identifier can be generated in any suitable manner. For example, storing a file 104 in the persistent storage device 102 can involve partitioning or otherwise dividing the file 104 into the blocks 106a-h. A process for dividing a file 104 into blocks can be executed to scan or otherwise access the content of the file 104. The process can partition or otherwise divide the file 104 into fixed-size or variably sized blocks. In some embodiments, the persistent storage device 102 can be configured to store blocks having a fixed length (e.g., each block having a length of 4 KB). In other embodiments, the persistent storage device 102 can be configured to store blocks having a variable lengths (e.g., a first block having a length of 4 KB, a second block having a length of 6 KB, a third block having a length of 64 KB, etc.). For each block, the process can execute a cryptographic hash function, such as SHA-1, for each of the blocks 106a-h. For each of the blocks 106a-h, a value that is calculated using the cryptographic hash function can be a fingerprint (i.e., a respective one of the block identifiers 110a-h).

A process for generating a file recipe 108 can output a tuple or other data set for each of the blocks 106a-h. For example, the tuple or other data set may include a fingerprint for each block, an offset for each block, and a length of each block. The fingerprints for the block 106a-h, the offsets for the blocks 106a-h, and the lengths of the blocks 106a-h can be stored as the file recipe 108. This process may be performed as part of a write operation or prior to one or more read operations. An example of a file recipe 108 generated using this process is provided below.

| Hash (md5-48 bit) | Offset (bytes) | Length (bytes) |
|---|---|---|
| be:b4:73:11:96:f1 | 0 | 1030 |
| 76:4e:9e:98:c1:b4 | 1030 | 3877 |
| eb:56:97:19:ee:67 | 4907 | 5714 |
| ba:68:3d:1f:fd:3d | 10621 | 1539 |
| dc:af:dc:8f:90:4c | 12160 | 3586 |
| 5f:e7:60:d6:b3:d4 | 15746 | 1700 |

The distributed computing system 100 can include a resource management module 112 and computing nodes 114a, 114b. As depicted in FIG. 1, the resource management module 112 and the computing nodes 114a, 114b can communicate with the persistent storage device 102 though the data network 115 to access data stored on the persistent storage media. For illustrative purposes, FIG. 1 depicts a distributed computing system 100 that includes two computing nodes 114a, 114b. However, any number of computing nodes can be included in a distributed computing system 100.

The resource management module 112 can be executed by one or more computing nodes or another suitable computing device or system. The resource management module 112 can manage resources of the distributed computing system. For example, the resource management module 112 can divide processing jobs into tasks and schedule or otherwise assign the tasks to different nodes in the distributed computing system 100 for parallel execution.

Each of the computing nodes 114a, 114b can include one or more processing devices and one or more memory devices. The processing devices can execute computer-readable instructions that configure the processing devices to perform specified functions. Examples of these computer-readable instructions include processing modules 116a, 116b, which can perform one or more operations using data that is cached or otherwise stored at the computing nodes 114a, 114b. The computing nodes 114a, 114b can also include one or more interface devices for communicating with data networks, other processing nodes, or other devices.

The computing nodes 114a, 114b can also include respective cache storage media 120a, 120b. Each of the cache storage media 120a, 120b includes data storage devices. For example, the cache storage media 120a, 120b may each include one or more hard disk drives), flash drives, tape drives, solid state drives, RAM, ROM, flash memory, other types of storage devices, or a combination thereof. The cache storage media 120a, 120b may be implemented within the respective computing nodes 114a, 114b, as separate devices, or in a combined form. The cache storage media 120a, 120b may be operated or utilized in a coordinated fashion.

Each of the cache storage media 120a, 120b can store one or more copies of the blocks 106a-h. For example, as depicted in FIG. 1, the cache storage medium 120a stores blocks 106a′, 106b′ that are respective copies of blocks 106a, 106b stored on the persistent storage device 102, and the cache storage medium 120b stores a block 106d′ that is a copy of the block 106d stored on the persistent storage device 102. The cache storage media 120a, 120b can also store other data blocks, such as blocks 122, 124, 126, 128, 130. Storing copies of data blocks in the cache storage media 120a, 120b can allow the data to be accessed more quickly for processing purposes than if the data was accessed from the persistent storage device 102. The size of the data blocks stored in the cache storage media 120a, 120b can correspond to the size of the data blocks used to perform de-duplication in the persistent storage device 102. For example, if the persistent storage device 102 utilizes fixed-size blocks, the cache storage media 120a, 120b can also utilize fixed-size blocks. If the persistent storage device 102 utilizes variably sized blocks, the cache storage media 120a, 120b can also utilize variably sized blocks.

The computing nodes 114a, 114b can also store respective block identifier indexes 118a, 118b that are used for managing the blocks stored in the cache storage media 120a, 120b. The block identifier indexes 118a, 118b can include information for accessing specific data blocks on the cache storage media 120a, 120b. For example, the block identifier index 118a can store block identifiers for blocks 106a′, 122, 124, 106b′ and corresponding locations in the cache storage medium 120a. The block identifier index 118b can store block identifiers for blocks 106d′, 126, 128, 130 and corresponding locations in the cache storage medium 120b. In some embodiments, the block identifier indexes 118a, 118b can be generated by obtaining some or all of a file recipe 108 for a given file 104 contemporaneously with the computing nodes 114a, 114b retrieving one or more of the data blocks 106a-h from the persistent storage device 102.

In some embodiments, the computing nodes 114a, 114b can implement de-duplicating, least-recently-used (“LRU”) caches to manage cache storage media. For embodiments in which the block identifiers are fingerprints generated as described above, each of the computing nodes 114a, 114b can maintain a fingerprint index (i.e., a block identifier index) in memory. The fingerprint index can be used by a computing node for finding a number of matching blocks in response to a request that includes one or more fingerprints or other block identifiers. The fingerprint index can map fingerprints to cached blocks using, for example, a hash table or other suitable data structure.

A fingerprint index or other block identifier index can also be used by a computing node for de-duplicating data blocks within the computing node. A fingerprint index or other block identifier index can allow the computing node to be aware of the content of the data blocks stored in the computing node, as the fingerprint or other block identified can be calculated, derived, or otherwise determined from the content of a given data block. Allowing the computing node to be aware of the content of data blocks rather than referencing data blocks in a positional manner can allow the computing node to identify duplicate blocks stored at the computing node and remove one or more duplicates. Any suitable de-duplication algorithm can be executed by a computing node using a fingerprint index or other block identifier index. De-duplicating content stored in a cache storage medium of a given computing node can improve caching efficiency at the computing node.

The data network 115 can include one or more devices for exchanging information. In various embodiments, the data network 115 can include one or more of a local area network, a wide-area network, a metropolitan area network, a telecommunications network, the Internet, or any combination thereof. The data network 115 can also include routers, hubs, computers, servers, or other types of computing devices. The data network 115 may include one or more of wired communication links, wireless communication links, or a combination thereof.

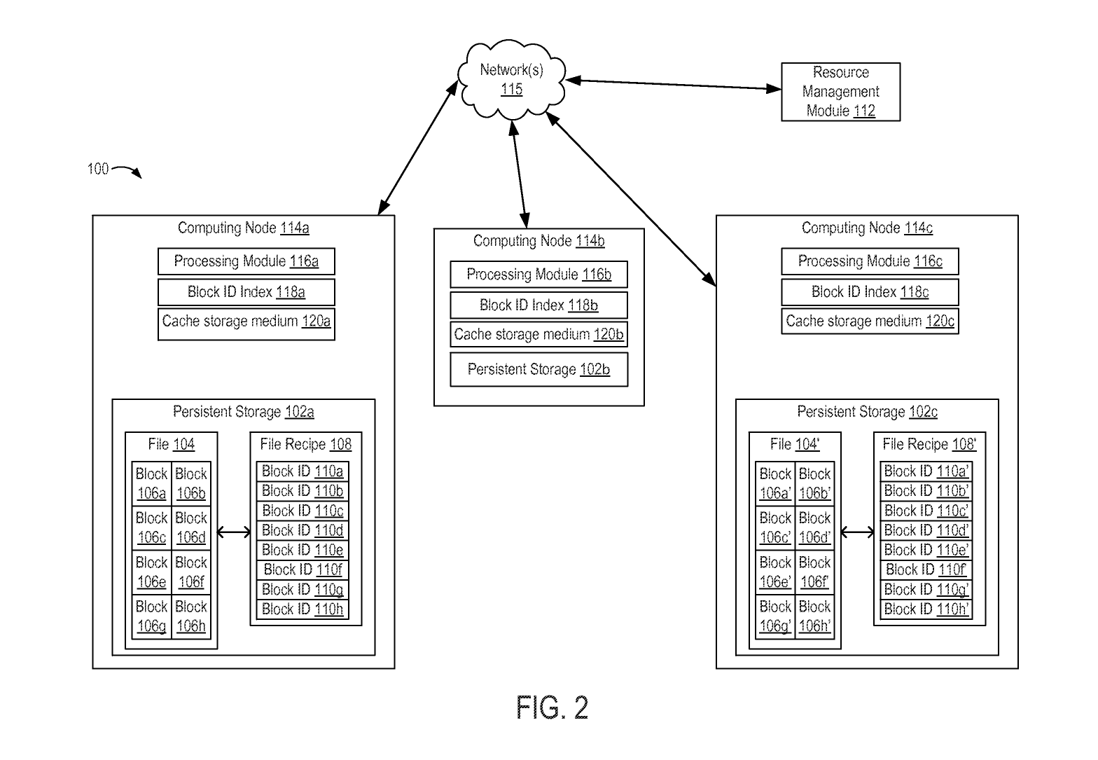

Although FIG. 1 depicts a persistent storage device 102 that is accessible by a distributed computing system 100 via a data network, other implementations are possible. For example, FIG. 2 is a block diagram depicting an alternative example of a distributed computing system 100 that can utilize a distributed file system to perform content-aware task assignment. As depicted in FIG. 2, each of the computing nodes 114a-c can include or be communicatively coupled to respective persistent storage devices 102a-c. The computing node 114a can store the file 104 and the file recipe 108 in the persistent storage device 102a. The computing node 114c can store a copied file 104′ including copied blocks 106a′-h′, and a copied file recipe 108′ include copied block identifiers 110a′-h′ in the persistent storage device 102c.

In some embodiments, a distributed computing system 100 can be used for performing data analytics on one or more files 104. For example, the distributed computing system 100 depicted in FIG. 2 can be implemented using a software framework such as Apache Hadoop® or another suitable framework that is designed for performing distributed data analytics on very large data sets. A Hadoop Distributed File System (“HDFS”) runs on top of the file systems of the underlying operating systems of the computing nodes 114a, 114b, 114c in a distributed computing system 100. The HDFS manages the storage of data sets and data blocks (also known as “chunks”) across the storage spaces associated with the computing nodes 114a, 114b, 114c. The distributed file system can accommodate the processing needs of the nodes as well as perform data reliability functions.

The distributed computing systems depicted in FIGS. 1 and 2 can be used to perform content-aware task assignment. Content-aware task assignment can involve scheduling or otherwise assigning tasks to specific computing nodes based on a similarity between the content that is associated with the task and content that is cached or otherwise stored in a computing node. For example, the resource management module 112 can receive a job submission that involves the file 104, obtain the file recipe for the file 104 from the persistent storage device 102, and, for each task of the job, assign a given task to the computing node having a sufficiently large number of data blocks associated with the task.

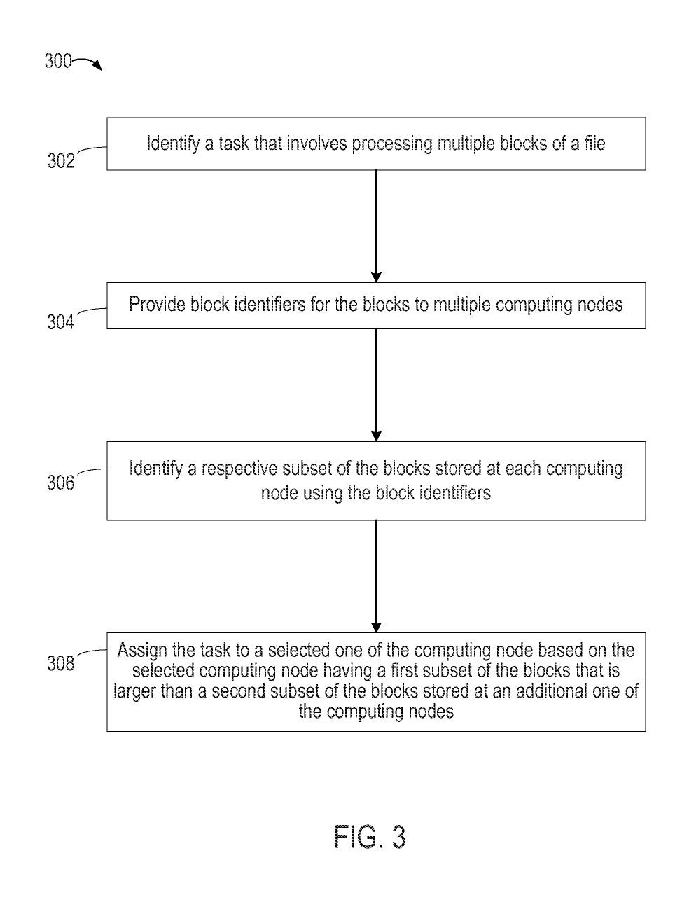

FIG. 3 is a flow chart depicting an example of a method 300 for performing content-aware task assignment in the distributed computing system 100. For illustrative purposes, the method 300 is described with reference to the devices depicted in FIGS. 1 and 2. Other implementations, however, are possible.

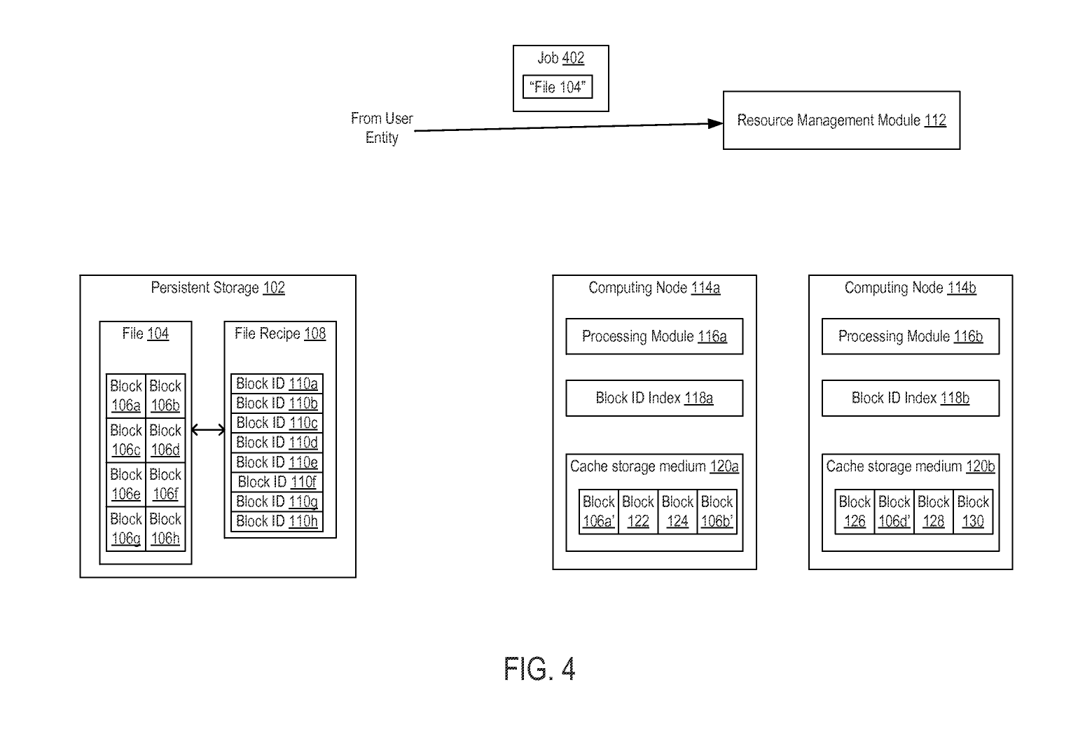

The method 300 involves identifying a task that involves processing multiple blocks of a file, as shown in block 302. One or more processing devices can execute the resource management module 112 or other suitable program instructions stored in a non-transitory computer-readable medium to identify a task that involves processing multiple blocks of a file 104. For example, the resource management module 112 may perform one or more of the operations depicted in FIGS. 4-6 to identify tasks and associated processing blocks.

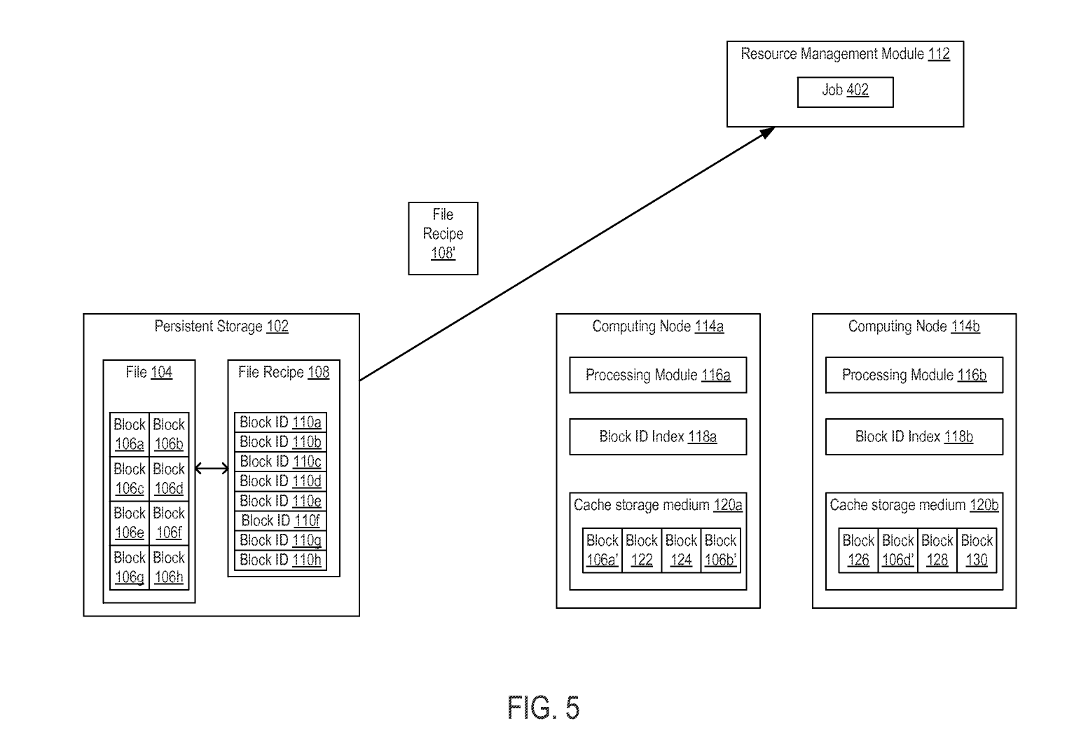

FIG. 4 depicts the resource management module 112 receiving a job 402 that can be executed using content-aware task assignment. The job 402 can include a reference to or otherwise be associated with the file 104. The resource management module 112 can use the file recipe 108 to partition or otherwise divide the job into tasks that may be executed in parallel. The resource management module 112 can request a copy of the file recipe 108 in response to receiving the job 402 and determining that the job 402 involves the file 104. For example, FIG. 5 depicts the resource management module 112 obtaining a copy of the file recipe 108′ for the file 104. The file recipe 108′ depicted in FIG. 5 includes block identifiers for the file 104. The resource management module 112 can retrieve or otherwise obtain the file recipe from the persistent storage device 102. In some embodiments, the persistent storage device 102 can be a server or other device that is accessible by the distributed computing system 100 via a data network 115, as depicted in FIG. 1. In additional or alternative embodiments, the persistent storage device 102 can be included in or communicatively coupled via a data bus to one or more of the computing nodes 114a, 114b, 114c, as depicted in FIG. 2.

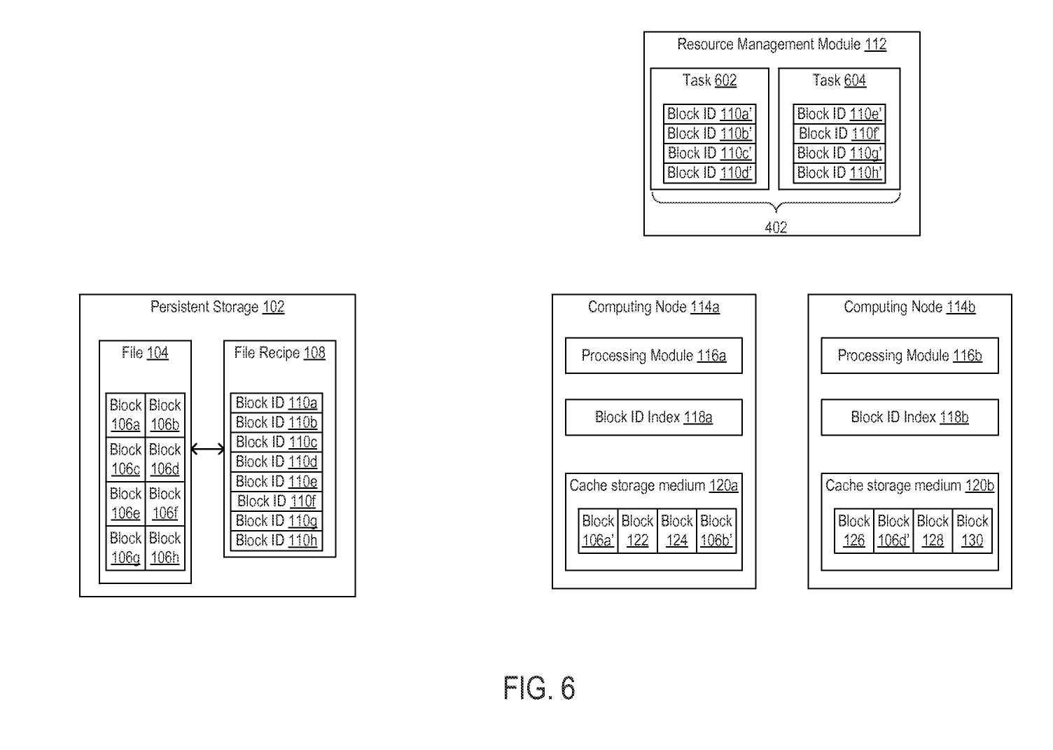

FIG. 6 depicts the resource management module 112 dividing the job 402 into tasks 602, 604 using the block identifiers 110a′-h′ from the obtained file recipe 108′. Each of the tasks into which a job 402 is subdivided can be associated with one or more blocks 106a-h of the file 104 using the block identifiers 110a-h (or copies thereof). A task may be, for example, a smallest modular unit of computation for the job 402. For example, a job 402 involving a file that is 1 GB in size may be divided into multiple tasks, each of which operates on a subset of the blocks in the file. Examples of such subsets include a subset of blocks having a combined size of 64 MB, a subset of blocks having a combined size of 128 MB, etc. As depicted in FIG. 6, the task 602 is associated with the blocks corresponding to the block identifiers 110a′-d′, and the task 604 is associated with the blocks corresponding to the block identifiers 110e′-h′.

An example of dividing a job 402 into tasks 602, 604 can include performing a MapReduce operation for analyzing data such as (but not limited to) user click streams, social network data, system log files, etc. A MapReduce operation can include a Map phase and a Reduce phase. In the Map phase, the distributed computing system 100 can be used to access a file 104 and generate key/value pairs. The Map phase can involve partitioning a copy of the file 104 into “splits” (e.g., portions of a file that are 64 MB in size), where one Map task is used to process each split. The block identifiers 110a′-d′ associated with the task 602 in FIG. 6 can identify a first “split” of the file 104 to be processed in the task 602, and the block identifiers 110e′-h′ associated with the task 602 in FIG. 6 can identify a second “split” of the file 104 to be processed in the task 604. In the Reduce phase, aggregations can be performed on the key/value pairs. The resource management module 112 can schedule each of the tasks 602, 604 to a computing node where data for the “split” in each of the tasks 602, 604 is stored.

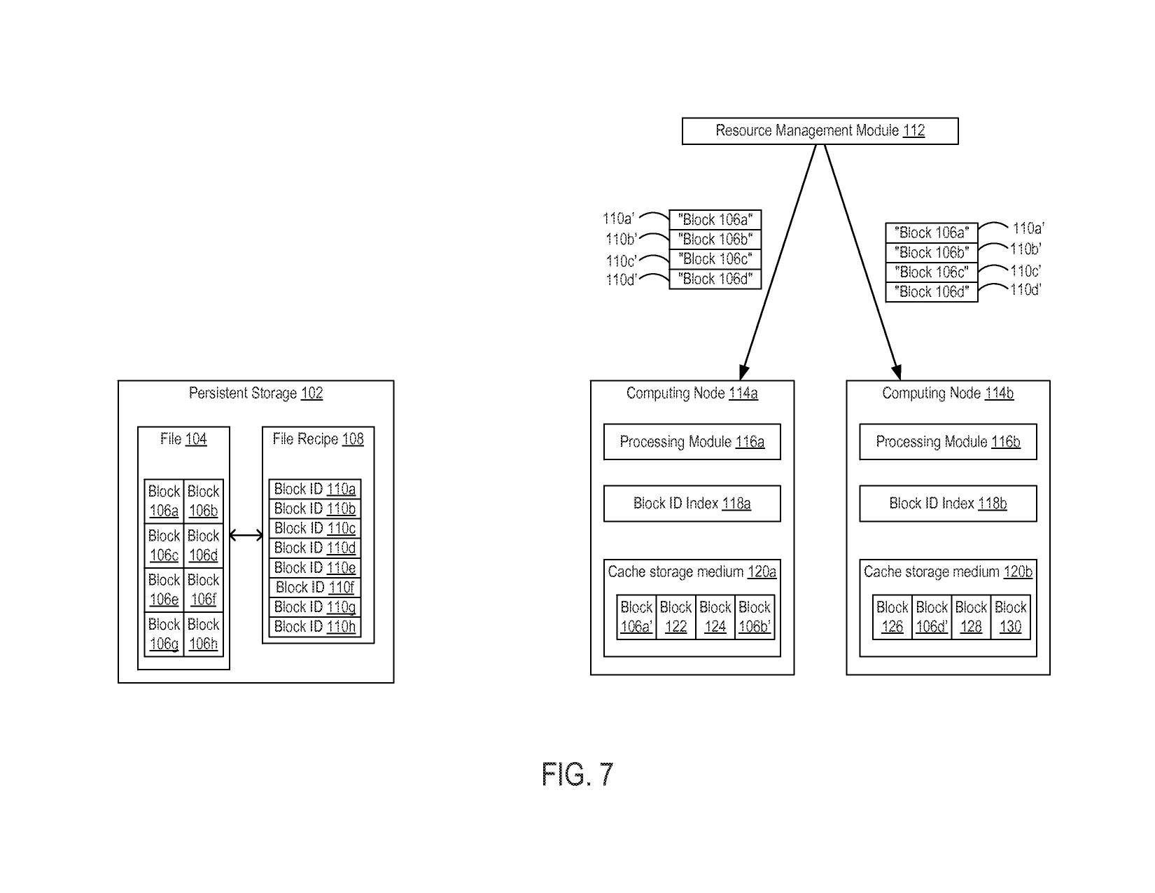

Returning to FIG. 3, the method 300 further involves providing block identifiers for the blocks to multiple computing nodes, as shown in block 304. One or more processing devices can execute the resource management module 112 or other suitable program instructions stored in a non-transitory computer-readable medium to provide block identifiers for the blocks to multiple computing nodes. For example, FIG. 7 depicts the resource management module 112 providing the block identifiers 110a′-d″ associated the task 602 to the computing nodes 114a, 114b. The block identifiers 110a′-d′ can respectively identify the blocks 106a-d. Block identifiers can be provided via any suitable electronic communication, such as (but not limited to) a message transmitted via one or more data networks 115.

Returning to FIG. 3, the method 300 further involves identifying a respective subset of the blocks cached or otherwise stored at each computing node using the block identifiers, as shown in block 306. For example, suitable processing devices can execute the processing modules 116a, 116b or other suitable program instructions stored in a non-transitory computer-readable medium to identify subsets of the blocks cached or otherwise stored at the computing nodes 114a, 114b. Each of the processing modules 116a, 116b can respond to receiving the block identifiers 110a′-d′ from the resource management module 112 by accessing a respective one of the block identifier indexes 118a, 118b stored in a non-transitory computer-readable medium included in or accessible to the computing node. Each of the processing modules 116a, 116b can compare the block identifiers 110a′-d′ received from the resource management module 112 to the block identifiers included in the respective block identifier indexes 118a, 118b. An example of pseudo-code for finding a number of matching blocks at a computing node is provided below.

```
Function name: getNumberofMatchingBlocks
Parameters: a collection of fingerprints (block identifiers)
belonging to a task
Return: number of matching blocks between the fingerprints in a
file split and cached blocks
int getNumberOfMatchingBlocks(Collection<FP> FPs) {
  int counter = 0;
  foreach FP in FPs:
  if (cache.contains(FP)) {
    counter++;
  }
  return counter;
}
```

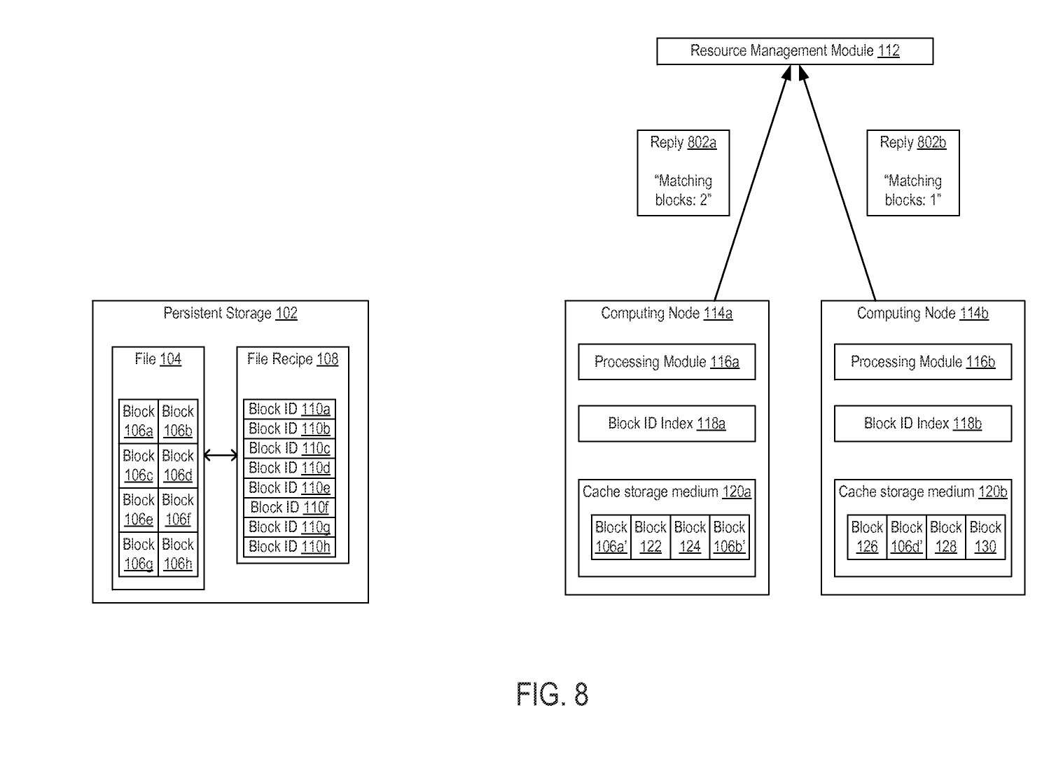

Each of the processing modules 116a, 116b can notify the resource management module 112 of a respective number of unique blocks corresponding to the block identifiers 110a′-d′ that are stored in a respective one of the cache storage media 120a, 120b. For example, as depicted in FIG. 8, the computing node 114a transmits a reply 802a to the resource management module 112 indicating that two blocks matching the block identifiers 110a′-d′ are stored in the cache storage medium 120a, and the computing node 114b transmits a reply 802b to the resource management module 112 indicating that one block matching the block identifiers 110a′-d′ is stored in the cache storage medium 120b. The resource management module 112 can identify respective subsets of the cached blocks 106a′-d′ or numbers of the cached blocks 106a′-d′ stored at each of the computing nodes 114a, 114b based on the replies 802, 804.

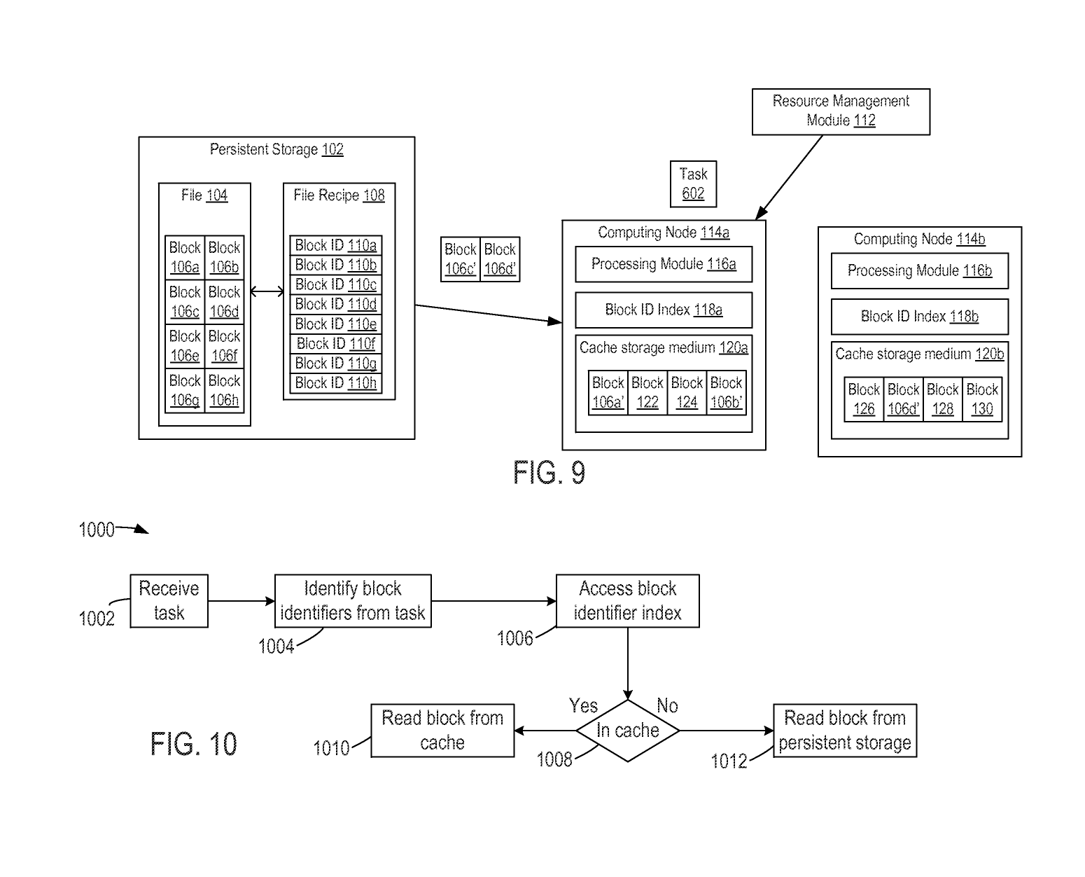

Returning to FIG. 3, the method 300 further involves assigning the task to a selected one of the computing nodes based on the selected computing node having a first subset of the blocks that is larger than a second subset of the blocks stored at an additional one of the computing nodes, as shown in block 308. For example, one or more processing devices can execute the resource management module 112 or other suitable program instructions stored in a non-transitory computer-readable medium to schedule or otherwise assign the task 602 to the computing node 114a, as depicted in FIG. 9. In some embodiments, a computing node may be selected based on the computing node having all blocks of the task stored in a cache storage media.

In some embodiments, a first computing node having a larger subset of blocks than a second computing node may involve the first computing node having a larger number of blocks than the second computing node. In some embodiments, a computing node having larger numbers of blocks (even smaller sized blocks) can be selected to perform a task rather than a computing node having a smaller number of blocks, even if the smaller number of blocks includes a larger amount of data than is cached at other computing nodes. For example, a first cost (e.g., processing resources, latency, etc.) that is associated with retrieving or reading multiple data blocks from the persistent storage device 102 may be larger than a second cost that is associated with reading or retrieving a single, larger block from the persistent storage device 102, even if the total size of the set of data blocks is less than the size of the single, larger data block. If so, the resource management module 112 can use the number of cached blocks to select a computing node for assigning a task rather than using the total size of cached blocks to select the computing node.

In additional or alternative embodiments, a first computing node having a larger subset of blocks than a second computing node may involve the first computing node having a number of blocks that have a larger total size than the second computing node. For such an embodiment, a first cost that is associated with retrieving or reading multiple data blocks having a small combined size may be smaller than a second cost that is associated with reading or retrieving a single, larger block. A lower cost may be associated with retrieving multiple small data blocks if computing node is configured to request multiple blocks from the persistent storage device 102 in a single operation. An amount of data (in bytes) that is cached on each node can be calculated to select a computing to which a task is to be assigned. A lower cost may be associated with retrieving multiple small data blocks if computing node is configured to request multiple blocks from the persistent storage device 102 in a single operation. An amount of data (in bytes) that is cached on each node can be calculated to select a computing to which a task is to be assigned. For example, in a distributed computing system 100 involving variably sized blocks, a task may be associated with a first block that is 64 KB in size, a second block that is 4 KB in size, and a third block that is 4 KB in size. A computing node having only the 64 KB block may be selected for the task even if another computing node has the two 4 KB blocks (i.e., has a greater number of blocks with a smaller total size).

The method 300 can also be performed for the task 604 and any other tasks into which the job 402 is subdivided. In some embodiments, multiple instances of the method 300 can be performed in parallel for some or all tasks associated with a job.

In additional or alternative embodiments, the resource management module 112 can provide all block identifiers 110a-h in the file recipe 108 to some or all of the computing nodes in a distributed computing system 100. Each of the computing nodes can respond to receiving the block identifiers 110a-h by identifying which of the block identifiers 110a-h are included in the computing node's block identifier index (i.e., which of the blocks 106a-h are stored at the computing node). Each of the computing nodes can provide a list or other data to the resource management module 112 identifying which of the blocks 106a-h are cached or otherwise stored at the computing node. The resource management module 112 can assign tasks to computing nodes based on the lists or other data received from the computing nodes identifying which of the blocks 106a-h are cached or otherwise stored at different computing nodes.

In some embodiments, multiple tasks may involve overlapping sets of data blocks. In these embodiments, the resource management module 112 may compare the cached data blocks at each computing node with blocks for a task to be assigned. The resource management module 112 may also use historical task assignment information to efficiently assign tasks to computing nodes.

In some embodiments, the resource management module 112 can utilize task scheduling history to optimize the assignment of tasks based on determining both the data blocks cached at a computing node prior to executing a given task and the data blocks cached at the computing node after executing the task. For example, a first task may involve blocks 1-10, and a second task may involve blocks 7-17. Prior to execution of either the first or second task, a first computing node may have blocks 1-7 and a second computing node may have blocks 7-9. In the absence of optimization, the first task may be assigned to the first computing node based on the first computing node having a larger subset of the blocks 1-10 (i.e., seven blocks 1-7 from the task blocks 1-10), and the second task may be assigned to the second computing node based on the second computing node having a larger subset of the blocks 7-17 (i.e., three blocks 7-9 from the task blocks 7-17). However, an optimization process performed by the resource management module 112 can be used to determine that the first computing node, after performing the first task that requires the first computing node to retrieve and cache the blocks 8-10, has blocks 1-10 and therefore has a larger subset of the blocks (i.e., blocks 7-10) involved in the second task. The optimization process may therefore cause the resource management module 112 to assign both the first and second tasks to the first computing node.

In some embodiments, the resource management module 112 can assign a task to a computing node from a group of computing nodes in the distributed computing system 100 that has the largest number of data blocks associated with the task.

In other embodiments, the resource management module 112 can assign a task based on the computing node that has a larger number of data blocks associated with the task than one or more other computing nodes even if the selected computing node does not have the largest number of data blocks associated with the task. For example, the resource management module 112 can generate a list of computing nodes that are ranked according to the number of data blocks associated with the task that are cached or otherwise stored at each computing node. The resource management module 112 can use the ranked list to assign tasks to computing nodes in combination with one or more other parameters, such as parameters indicative of the performance of one or more computing nodes.

One example of such a parameter is the processing capability of each computing node. For instance, the highest-ranked computing node (i.e., the computing node with the largest number of data blocks associated with the task) may have fewer available processing resources (e.g., available processing cycles, available memory, etc.) than a lower-ranking computing node. The resource management module 112 may assign the task to the lower-ranking computing node based on the lower-ranking computing node having a greater processing capability than the highest-ranked computing node.

Another example of such a parameter is the responsiveness of each computing node. For instance, the highest-ranked computing node (i.e., the computing node with the largest number of data blocks associated with the task) may have a less reliable connection to the data network 115 than a lower-ranking computing node. A reliability of a connection can be determined based on one or more of a latency associated with the connection and a bandwidth associated with the connection. The resource management module 112 may assign the task to the lower-ranking computing node based on the lower-ranking computing node having a more reliable network connection or other measure of responsiveness than the highest-ranked computing node.

Another example of such a parameter is the proximity between sets of computing nodes. Assigning multiple tasks in a job to computing nodes located in the same rack or network location may increase processing efficiency for the job. For instance, a first set of computing nodes may be located in a first rack or network location and a second set of computing nodes may be located in a second rack or network location. A job to be assigned may include three tasks. The highest-ranked computing node for the first task may be located in the first rack or network location, and the highest-ranked computing nodes for the second and third tasks may be located in the second rack or network location. The resource management module 112 may assign all three tasks to one or more computing nodes based on the computing nodes being located in the second rack or network location even if one or more of the computing nodes is not the highest-ranked node for one or more of the tasks.

As depicted in FIG. 9, the computing node 114a to which a task 602 is assigned can obtain copied blocks 106c′, 106d′ associated with the task 602 from the persistent storage device 102. For example, FIG. 10 is a flow chart depicting an example of a method 1000 executed by a computing node 114a obtain copies of blocks 106a-d associated with the task 602. For illustrative purposes, the method 1000 is described with reference to the devices depicted in FIGS. 1-9. Other implementations, however, are possible.

The method 1000 involves receiving the task 602, as shown in block 1002. The computing node 114a can receive the task 602 as described above with respect to FIG. 9.

The method 1000 further involves identifying a block identifier associated with executing the task 602, as shown in block 1004. For example, the processing module 116a can be executed to access the block identifiers 110a′-d′ included in or otherwise associated with the task 602. One or more of the block identifiers 110a′-d′ can be accessed in response to encountering a read operation referencing one or more of the blocks 106a-d.

The method 1000 further involves accessing the block identifier index 118a, as shown in block 1006. For example, the block identifier index 118a may be stored in a non-transitory computer-readable medium that is included in or communicatively coupled to the computing node 114a. The processing module 116a can be executed by a suitable processing device to access the block identifier index 118a from the computer-readable medium.

The method 1000 further involves determining whether the block that is associated with a given block identifier is stored in the cache storage medium 120a, as shown in block 1008. For example, the processing module 116a can determine whether a given block identifier matches any of the entries in the accessed block identifier index 118a. If so, the method 1000 further involves reading the block from the cache storage medium 120a, as shown in block 1010. If not, the method 1000 further involves reading or retrieving the block from the persistent storage device 102, as shown in block 1012.

The method 1000 can allow one or more of the computing nodes 114a, 114b to avoid duplicating content stored in the cache. For example, executing the method 1000 can allow a computing node to determine whether a specific item of content is stored in the cache storage medium, as the block identifiers used in the method 1000 can be fingerprints or other data that is calculated, computed, derived, or otherwise determined from the content of a given data block. Checking for the presence or absence of specific content in a cache using a block identifier index prior to retrieving the content from the persistent storage device 102 can avoid the storage of duplicate data blocks in a given computing node. An example of pseudo-code for implementing one or more operations in the method 1000 is provided below.

```
Buffer read(filename, offset, length) {
    Buffer buffer = new Buffer(length);
    Hash<FP, <offset, length>> FPs =
        FileRecipeCache.getFingerprints(filename, offset,
        length);
    foreach FP in FPs.keys( ):
        if (cache.contains(FP)){
            buffer.add(cache.get(FP));
        } else {
            block = readFromNFS (filename,
            FPs.get(FP).offset, FPs.get(FP).length);
              buffer.add(block);
        }
}
```

A computing node can maintain a file recipe cache for every task assigned to the computing node. A file recipe cache can be wholly or partially included in a block identifier index of a computing node. The resource management module 112 can send the file recipe or a portion thereof that is applicable to a given task to the computing node in conjunction with assigning the task to the computing node. An example of pseudo-code for obtaining a file recipe is provided below:

```
Hash<FP, <offset, length>> FileRecipeCache.getFingerprints
(filename, offset, length) {
    FileRecipe = FileRecipeCache.get(filename);
    return FileRecipe.getFingerprints(offset, length);
}
Hash<FP, <offset, length>> FileRecipe.getFingerprints(offset, length) {
Hash<FP, <offset, length>> blocks = new Hash<FP, <offset,
    length>>( );
    // find the first block, covering offset
    foreach block in FileRecipe {
        if (block.offset < offset && block.offset + block.length
        > offset) {
    break;
        }
    }
    // get all blocks, covering the next length bytes
    While(block.offset + block.length < offset+length) {
        Blocks.add(block);
        Block = FileRecipe.nextBlockRecord( );
    }
  return blocks;
}
```

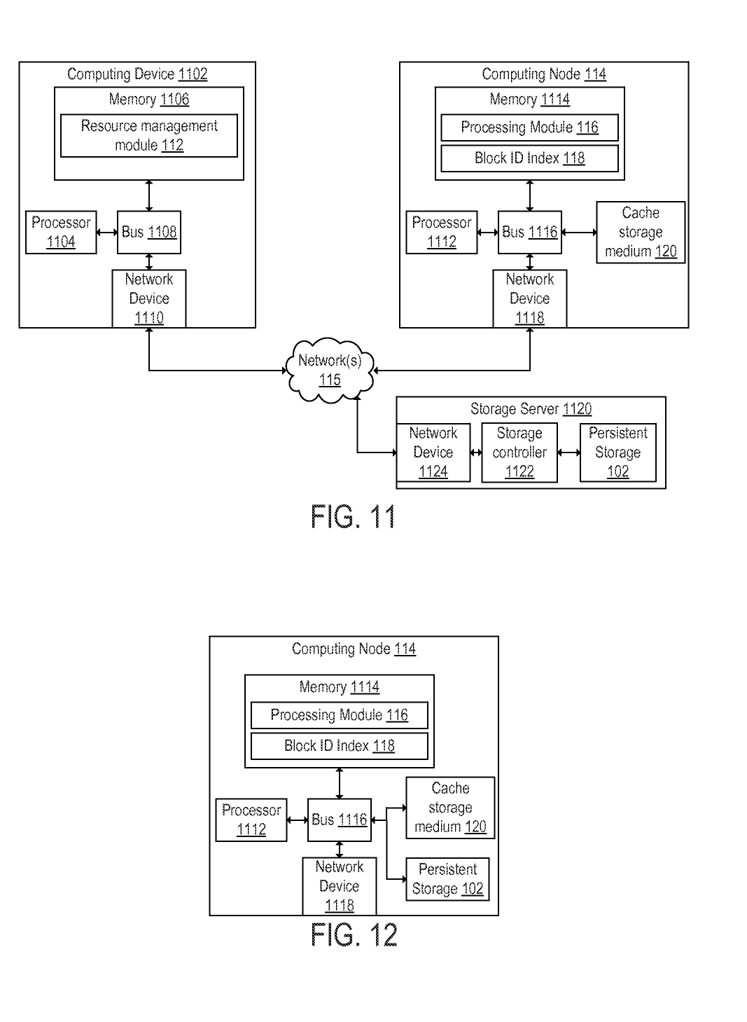

Any suitable system implementation can be used for the devices and methods described above with respect to FIGS. 1-10. For example, FIG. 11 is a block diagram depicting examples of a computing node 114, a computing device 1102, and a storage system 1120 used in content-aware task assignment. The computing device 1102 can include any suitable device for managing resources in the distributed computing system 100. In some embodiments, the computing device 1102 can include one or more computing nodes of the distributed computing system 100.

The computing device 1102 and the computing node 114 can respectively include processors 1104, 1112 that are communicatively coupled to respective memory devices 1106, 1114. The processors 1104, 1112 can execute computer-executable program code and/or access information stored in the memory devices 1106, 1114. The processor 1104 can execute a resource management module 112 and/or other computer-executable program code stored in the memory device 1106. The processor 1112 can execute a processing module 116 and/or other computer-executable program code stored in the memory device 1114. When executed by the processors 1104, 1112, the program code stored in the memory devices 1106, 1114 can cause the processors 1104, 1112 to perform the operations described herein. Each of the processors 1104, 1112 may include a microprocessor, an application-specific integrated circuit (“ASIC”), a state machine, or other suitable processing device. Each of the processors 1104, 1112 can include any number of processing devices, including one.

Each of the memory devices 1106, 1114 can include any suitable computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, ROM, RAM, an ASIC, a configured processor, optical storage, magnetic tape or other magnetic storage, or any other medium from which a computer processor can read program code. The program code may include processor-specific instructions generated by a compiler and/or an interpreter from code written in any suitable computer-programming language, including, for example, Hadoop®, C, C++, C#, etc.

The computing node 114 can also include a cache storage medium 120. In some embodiments, the memory device 1114 and the cache storage medium 120 can be separate devices, as depicted in FIG. 11. In other embodiments, the memory device 1114 and the cache storage medium 120 can be the same device.

The computing device 1102 and the computing node 114 can also respectively include buses 1108, 1116. Each of the buses 1108, 1116 can communicatively couple one or more components of a respective one of the computing device 1102 and the computing node 114. Each of the buses 1108, 1116 can include one or more devices for coupling various components, such as (but not limited to) a memory bus, a system interconnect device, etc.

The storage server 1120 can include the persistent storage device 102 and a storage controller 1122. The storage controller 1122 can include one or more physical processing devices that are used to store and retrieve data on behalf of one or more hosts. The storage controller 1122 can be configured (e.g., by hardware, software, firmware, or any combination thereof) to serve one or more clients on a network and to store and manage data in a set of mass storage devices, such as the persistent storage device 102. The storage controller 1122 can include one or more ports having input/output interface circuitry that can communicatively couple to the persistent storage device 102 using, for example, a serial attached SCSI (“SAS”) topology, a conventional serial ATA (SATA) topology, a PCI topology, or another suitable topology. File systems that can be used in the storage server 1120 may include a Write Anywhere File Layout (“WAFL”), a Third Extended File System (“ext3”), a ZFS, a New Technology File System (“NTFS”), etc. In some embodiments, the storage server 1120 can be implemented using industry standard hardware and software solutions without modifications or variations to accommodate the specific file management needs of the distributed processing environment or framework.

The computing device 1102 can also include one or more network devices 1110, the computing node 114 can include one or more network devices 1118, and the storage server 1120 can include one or more network devices 1124. The network devices 1110, 1118, 1124 can include any device or group of devices suitable for establishing a wireless data connection. Non-limiting examples of the network devices 1110, 1118, 1124 include one or more of an Ethernet network adapter, an RF transceiver, a modem, an optical emitter, an optical transceiver, etc.

In additional or alternative embodiments, a distributed persistent storage system can be implemented using multiple persistent storage devices at respective compute nodes. For example, FIG. 12 is a block diagram depicting an alternative example of a computing node 114 that includes the persistent storage device 102 coupled to the bus 1116. The persistent storage device 102 can be included in a computing node 114. A set of the computing nodes 114 depicted in FIG. 12 can be configured as a distributed computing system, with the associated persistent storage devices being configured as a distributed persistent storage system.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

In the figures described above, the numbers of devices depicted or described are used for illustrative purposes only. Other implementations are possible. For example, any number of devices or components described above may be used to implement the subject matter described herein.

The system or systems discussed herein are not limited to any particular hardware architecture or configuration. A computing device, a computing node, and a computing system can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Some embodiments described herein may be conveniently implemented using a conventional general purpose or a specialized digital computer or microprocessor programmed according to the teachings herein, as will be apparent to those skilled in the computer art. Some embodiments may be implemented by a general purpose computer programmed to perform method or process steps described herein. Such programming may produce a new machine or special purpose computer for performing particular method or process steps and functions (described herein) pursuant to instructions from program software. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information may be represented using any of a variety of different technologies and techniques.

Some embodiments include a computer program product comprising a computer readable medium (media) having instructions stored thereon/in and, when executed (e.g., by a processor), perform methods, techniques, or embodiments described herein, the computer readable medium comprising instructions for performing various steps of the methods, techniques, or embodiments described herein. The computer readable medium may comprise a non-transitory computer readable medium. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

The various illustrative logical blocks, modules, and circuits described in connection with the embodiments disclosed herein may be implemented or performed with a general-purpose processing device, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processing device may be a microprocessor, but in the alternative, the processor may be any conventional processor, controller, microcontroller, or state machine. A processing device may also be implemented as a combination of computing devices, e.g., a combination of a DSP and a microprocessor, a plurality of microprocessors, one or more microprocessors in conjunction with a DSP core, or any other such configuration.

Embodiments of the methods disclosed herein may be performed in the operation of such computing devices. The order of the blocks presented in the figures described above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific examples thereof, it will be appreciated that those skilled in the art, upon attaining an understanding of the foregoing may readily produce alterations to, variations of, combinations of, and equivalents to such embodiments and examples. Accordingly, it should be understood that the present disclosure has been presented for purposes of example rather than limitation, and does not preclude inclusion of such modifications, combinations, variations, and/or additions to the present subject matter as would be readily apparent to one of ordinary skill in the art.

1. A computer-implemented method comprising:
identifying a task associated with a file, wherein the task involves processing a plurality of blocks of the file;
providing, to each of a plurality of computing nodes, a respective block identifier for each of the plurality of blocks of the file;
identifying, for each computing node of the plurality of computing nodes, a respective subset of blocks from the plurality of blocks that is stored in a respective cache storage medium at the computing node, wherein each of the respective subsets of blocks is identified from the block identifiers;
assigning the task to a first computing node from the plurality of computing nodes based on the first computing node having a first subset of the plurality of blocks that is larger than a second subset of the plurality of blocks stored at a second computing node from the plurality of computing nodes; and
executing the task at the first computing node.

2. The computer-implemented method of claim 1, wherein the block identifiers are generated by executing, for each block of the plurality of blocks, a cryptographic hash function on respective content of the block to obtain the respective block identifier.

3. The computer-implemented method of claim 1, wherein the respective subset of blocks is identified at each computing node by determining that a corresponding subset of the block identifiers is included in a respective block identifier index stored at the computing node.

4. The computer-implemented method of claim 3, wherein at least one of the plurality of blocks is de-duplicated by at least one computing node of the plurality of computing nodes using a block identifier index stored at the at least one computing node.

5. The computer-implemented method of claim 3, wherein at least one block identifier index is generated by performing operations comprising:
receiving, by at least one computing node, an additional task and a subset of block identifiers associated with the additional task;
identifying at least one block from the plurality of blocks using at least one block identifier of the subset of block identifiers;
determining that the at least one block identified by the at least one block identifier is not stored in at least one cache storage medium of the at least one computing node;
retrieving the at least one block from a persistent memory storage device; and
adding the at least one block identifier to the at least one block identifier index.

6. The computer-implemented method of claim 1, further comprising obtaining a file recipe associated with the file from a persistent storage device in response to receiving a job and dividing the job into the task and at least one additional task using the file recipe, wherein the file recipe comprises the block identifiers and offsets for the plurality of blocks as stored at the persistent storage device.

7. The computer-implemented method of claim 1, further comprising determining that a third computing node from the plurality of computing nodes has a third subset of the plurality of blocks that is larger than the first subset of the plurality of blocks, wherein assigning the task to the first computing node comprises:
determining that a parameter associated with respective performances of the first computing node and the third computing node has a higher value for the first computing node than the third computing node; and
assigning the task to the first computing node based the parameter having the higher value for the first computing node.

8. The computer-implemented method of claim 7, wherein the parameter comprises at least one of an amount of processing capability of the computing node, a reliability of the computing node, and a location of the computing node.

9. A non-transitory machine-readable medium having stored thereon instructions for performing a method comprising machine executable code that when executed by at least one machine, causes the machine to:
identify a task associated with a file, wherein the task involves processing a plurality of blocks of the file;
provide, to each of a plurality of computing nodes, a respective block identifier for each of the plurality of blocks of the file;
identify, for each computing node of the plurality of computing nodes, a respective subset of blocks from the plurality of blocks that is stored in a respective cache storage medium at the computing node, wherein each of the respective subsets of blocks is identified from the block identifiers;
assign the task to a first computing node from the plurality of computing nodes based on the first computing node having a first subset of the plurality of blocks that is larger than a second subset of the plurality of blocks stored at a second computing node from the plurality of computing nodes; and
execute the task at the first computing node.

10. The non-transitory machine-readable medium of claim 9, wherein the machine executable code, when executed by the at least one machine, further causes the machine to generate the block identifiers by executing, for each block of the plurality of blocks, a cryptographic hash function on respective content of the block to obtain the respective block identifier.

11. The non-transitory machine-readable medium of claim 9, wherein the machine executable code, when executed by the at least one machine, further causes the machine to identify each respective subset of blocks comprises program code for determining, for each computing node, that a corresponding subset of the block identifiers is included in a respective block identifier index stored at the computing node.

12. The non-transitory machine-readable medium of claim 11, wherein the machine executable code, when executed by the at least one machine, further causes the machine to de-duplicate at least one of the plurality of blocks at at least one computing node of the plurality of computing nodes using a block identifier index stored at the at least one computing node.

13. The non-transitory machine-readable medium of claim 9, wherein the machine executable code, when executed by the at least one machine, further causes the machine to determine that a third computing node from the plurality of computing nodes has a third subset of the plurality of blocks that is larger than the first subset of the plurality of blocks, wherein assigning the task to the first computing node comprises:
determining that a parameter associated with respective performances of the first computing node and the third computing node has a higher value for the first computing node than the third computing node, wherein the parameter comprises at least one of an amount of processing capability of the computing node, a reliability of the computing node, and a location of the computing node; and
assigning the task to the first computing node based the parameter having the higher value for the first computing node.

14. A system comprising:
a memory containing a machine readable medium comprising machine executable code having stored thereon instructions for performing a method; and
a processor coupled to the memory, the processor configured to execute the machine executable code to cause the processor to:
identify a task associated with a file, wherein the task involves processing a plurality of blocks of the file,
provide, to each of a plurality of computing nodes, a respective block identifier for each of the plurality of blocks of the file,
identify, for each computing node of the plurality of computing nodes, a respective subset of blocks from the plurality of blocks that is stored in a respective cache storage medium at the computing node, wherein each of the respective subsets of blocks is identified from the block identifiers, and
assign the task to a first computing node from the plurality of computing nodes based on the first computing node having a first subset of the plurality of blocks that is larger than a second subset of the plurality of blocks stored at a second computing node from the plurality of computing nodes.

15. The system of claim 14, wherein at least one of the processor and an additional processor is configured for generating the block identifiers by executing, for each block of the plurality of blocks, a cryptographic hash function on respective content of the block to obtain the respective block identifier.

16. The system of claim 14, wherein the respective subset of blocks is identified at each computing node by determining that a corresponding subset of the block identifiers is included in a respective block identifier index stored at the computing node.

17. The system of claim 16, wherein at least one of the processor and an additional processor is further configured for de-duplicating at least one of the plurality of blocks by at least one computing node of the plurality of computing nodes using a block identifier index stored at the at least one computing node.

18. The system of claim 16, wherein at least one of the processor and an additional processor is further configured for generating at least one block identifier index by performing additional operations comprising:
receiving, by at least one computing node, an additional task and a subset of block identifiers associated with the additional task;
identifying at least one block from the plurality of blocks using at least one block identifier of the subset of block identifiers;
determining that the at least one block identified by the at least one block identifier is not stored in at least one cache storage medium of the at least one computing node;
retrieving the at least one block from a persistent memory storage device; and
adding the at least one block identifier to the at least one block identifier index.

19. The system of claim 14, wherein the processor is further configured for obtaining a file recipe associated with the file from a persistent storage device in response to receiving a job and dividing the job into the task and at least one additional task using the file recipe, wherein the file recipe comprises the block identifiers and offsets for the plurality of blocks as stored at the persistent storage device.

20. The system of claim 14, wherein the processor is further configured for determining that a third computing node from the plurality of computing nodes has a third subset of the plurality of blocks that is larger than the first subset of the plurality of blocks, wherein assigning the task to the first computing node comprises:
determining that a parameter associated with respective performances of the first computing node and the third computing node has a higher value for the first computing node than the third computing node, wherein the parameter comprises at least one of an amount of processing capability of the computing node, a reliability of the computing node, and a location of the computing node; and
assigning the task to the first computing node based the parameter having the higher value for the first computing node.
